(19) United States
(12) Patent Application Publication
(10) Pub. No.: US 2019/0019108 A1
(43) Pub. Date: Jan. 17, 2019

(54) SYSTEMS AND METHODS FOR A VALIDATION TREE

(71) Applicant: General Electric Company, Schenectady, NY (US)

(72) Inventor: Damian Ryan Eads, San Francisco, CA (US)

(21) Appl. No.: 15/892,400

(22) Filed: Feb. 8, 2018

Related U.S. Application Data
(60) Provisional application No. 62/532,221, filed on Jul. 13, 2017.

(51) Int. Cl. G06N 99/00; G06F 17/30

(52) U.S. Cl. CPC G06N 99/005; G06F 17/30312

(57) ABSTRACT

Various embodiments provide a validation decision tree, which is a type of decision tree that assists in tuning hyperparameters used to build or train another decision tree, which may be a traditional decision tree. In particular, some embodiments use a validation decision tree or a validation decision tree ensemble to evaluate a space of hyperparameters for a decision tree. Additionally, some embodiments use a validation decision tree or a validation decision tree ensemble to evaluate the space of hyperparameters without need for retraining the validation decision tree or validation decision tree ensemble.

### CROSS-REFERENCE TO RELATED APPLICATION

This application claims priority to and the benefit of U.S. Provisional Patent Application No. 62/532,221, filed on Jul. 13, 2017, which is incorporated herein by reference in its entirety.

### TECHNICAL FIELD

The present application relates to machine learning and, more particularly, adjusting or tuning machine learning (ML) models.

### BACKGROUND

Machine learning algorithms use historical data to produce machine learning (ML) models, such as binary classifiers, neural networks, and decision trees, that can predict outcomes on future input data. Generally, a learning or training algorithm learns or trains such a ML model by first accepting one or more parameters, referred to as hyperparameters, as input prior to learning/training the ML model, and then learning other parameters of the ML model based on historical data, which can serve as training or validation datasets for the ML model. In this way, hyperparameters and learned parameters of a ML model can determine operation and performance of the ML model. In other words, a ML model produces outcome data based on input data as a function of the ML model's hyperparameters and learned parameters.

Model tuning is the process of selecting one or more hyperparameters to train and build better ML models. Model tuning can improve a ML model by increasing the ML model's accuracy, controlling the ML model's resource usage, or lowering the ML model's prediction time. Traditionally, values for the hyperparameters have been selected manually by a human engineer based on their experience or by repeated experiments on validation datasets. This usually requires time and can result in sub-optimal hyperparameters. Alternatively, brute-force approaches, such as grid search, have been used to select hyperparameters, but this can be computationally expensive and slow given that the brute-force approaches explore a high-dimensional space of parameters. However, these approaches are inadequate for tuning ML models for highly data intensive operations that are now possible with advances in, e.g., big data processing, sensors and communications infrastructure that can be found in complex Internet of Things (IoT) and Industrial Internet of Things (IIoT) environments. Moreover, computational power and existing techniques are not capable of tuning ML models in a way that is acceptable for such applications.

### BRIEF DESCRIPTION OF THE DRAWINGS

Some embodiments are illustrated by way of example and not limitation in the figures of the accompanying drawings.

FIG. 1 is a block diagram illustrating an example networked system including a validation decision tree ensemble model component, in accordance with some embodiments of the present disclosure of the present disclosure.

FIG. 2 is a block diagram illustrating an example system including a validation tree ensemble model component, in accordance with some embodiments of the present disclosure.

FIG. 3 is a flowchart illustrating an example method for a validation decision tree ensemble, according to some embodiments of the present disclosure.

FIG. 4 is a flowchart illustrating an example method for generating a validation decision tree, according to some embodiments of the present disclosure.

FIG. 5 is a flowchart illustrating the flow of an example method for exploring a set of hyperparameters for a machine learning (ML) model, according to some embodiments of the present disclosure.

FIG. 6 is a block diagram illustrating an example software architecture, which may be used in conjunction with various hardware architectures herein described, according to various embodiments of the present disclosure.

FIG. 7 is a block diagram illustrating components of an example machine able to read instructions from a machine storage medium and perform any one or more of the methodologies discussed herein, according to various embodiments of the present disclosure.

### DETAILED DESCRIPTION

Various embodiments described herein implement a novel validation decision tree, which is a type of decision tree that assists in tuning hyperparameters used to build or train another decision tree, which may be a traditional decision tree. In particular, some embodiments use a validation decision tree or a validation decision tree ensemble to evaluate a space of hyperparameters for a decision tree. Additionally, some embodiments use a validation decision tree or a validation decision tree ensemble to evaluate the space of hyperparameters without need for retraining the validation decision tree or validation decision tree ensemble. Examples of hyperparameters evaluated by an embodiment may include, without limitation, a collapsible parameter described herein. Certain embodiments can be used as an adjunct of other methods to optimize one or more hyperparameters, such as those not hyperparameters not evaluated by the certain embodiments. As a result, embodiments of the validation decision tree disclosed herein improve on the prior art by facilitating faster and more optimal hyperparameter tuning, which in turn can improve operation and performance of ML models in data-intensive operations, such as those required in complex IIoT platforms.

As used herein, a hyperparameter can comprise a parameter provided as input to a learning or training algorithm that generates a ML model, such as a decision tree. A hyperparameter may be considered a hard parameter if it is tunable or non-static. Additionally, a hard parameter can be either collapsible or non-collapsible, where a collapsible hard parameter may be one that can be optimized by an embodiment described herein while a non-collapsible hard parameter may be one that cannot be optimized by an embodiment described herein. Examples of collapsible hard parameters include, without limitation, maximum depth, node size, number of trees, and node histograms. The maximum depth parameter may specify the maximum number of edges between a root node and a leaf node, the node size parameter may specify the minimum number of input vectors that fall into a node, the number of trees parameter may specify the number of decision trees in a decision tree ensemble, and the node histograms parameter may specify whether to use histogram predictions for leaf-node predictions within a decision tree. Examples of non-collapsible hard parameters include, without limitation: mtry, which is the number of features to explore per split within a decision tree ensemble; splitting criterion (e.g., gini, information gain, variance, etc.); and ZIF/zero information features, which represents the action to take in response to a feature that is explored that contributes 0 to the reduction in loss for a split.

As also used herein, a decision tree can comprise a tree-like graph of decisions and their possible consequences, and can further comprise probabilities for those consequences. A validation decision tree may comprise a type of decision tree user to tune hyperparameters in accordance with an embodiment described herein. A validation decision tree ensemble may comprise a plurality of decision trees in accordance with an embodiment described herein. At least some portion of a validation decision tree ensemble may be generated using a common or traditional machine learning technique, such as a RANDOM FOREST-or decision forest-based algorithm.

For various embodiments, a validation decision tree ensemble comprises multiple validation decision trees, which vote together on predictions. In a node histograms variant of a validation decision tree ensemble, a histogram of proportions of each label of training input vectors that fell into a node are stored. Various embodiments described here improve a computer system's ability to select or tune one or more values for hyperparameters for building or training a decision tree, and may do so by at least reducing the time, improving the quality, or reducing the computational expense of selecting/tuning the one or more. Improved quality of the values can also improve the performance or accuracy of the decision tree or decision tree ensemble built or trained using the values.

The description that follows describes systems, methods, techniques, instruction sequences, and devices that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

As used herein, a decision tree classifier (hereafter, decision tree) may comprise a type of ML model that makes a single prediction on a multi-typed vector. It may comprise a rooted binary tree, and embedded in every node of the decision tree is a decision function. This decision function can be fed a vector as input and the output determines which of the node's children becomes the current working node. Predicting on a new vector starts at the root, ie, the root is the current working node. The current working node's decision function may be fed the input vector and the current working node may be updated according to the output. This process of applying the decision function and updating the current working node may be repeated until the current working node is a leaf node. The leaf node can be used to make a prediction. For this description, the foregoing decision tree process may hereafter be referred to as a Decision Tree Prediction (DTPredict) procedure. As used herein, an input vector falls into a node N when a DTPredict procedure is applied to the input vector and the node N becomes a current working node at any point during the DTPredict procedure.

Each leaf node of a decision tree can embed metadata that can be used to make a prediction at the leaf node. The following are examples of prediction procedures that may be used to produce a prediction from a decision tree.

One example of a prediction procedure for a decision tree is the Classical Leaf Node Prediction (CLNPredict). CLNPredict may be used where metadata of a leaf node comprises a raw prediction value. This value L may be the prediction output of a single decision tree. In an ensemble of multiple decision trees, the prediction output of a single decision tree represents one vote for L. The votes for decision trees in a decision tree ensemble can be recorded in a data structure called a ballot. The ballot may comprise a look-up table for each possible prediction output and the number of votes cast for it. As used herein, ensemble can comprise multiple ML models (e.g., decision trees) that vote together.

Another example prediction procedure for a decision tree is the Node Histogram Prediction (NHPredict), which can cast votes for multiple predictions, each of which may comprise a label (e.g., label to a vector of parameters). Each label may have a vote between 0 and 1. The sum of votes for a single decision tree may not exceed 1. The NHPredict procedure may cause each node to store for each possible label the proportion of input vectors used during the training procedure that fell into the node. In some cases, a set of training vectors may have a large number of possible labels, where each possible label represents a class. Proportions may be zero, which can result in a significant storage requirement to store every proportion. In such cases, a sparse vector representation may be used, which may involve storing (label, proportion) pairs where the proportion is non-zero. Using NHPredict, the output of a single decision tree may be real-valued votes between 0 and 1 for each class. NHPredict may vote c_i for each class i represented in the sparse vector. The c_i values may be non-negative and may sum to 1.

Another example prediction procedure for a decision tree comprises Regression Node Prediction (RNPredict), which can predict a single real-value. In an ensemble, the average of such real-values can represent the sum of the prediction.

Another example prediction procedure for a decision tree comprises the User-defined Node Prediction (UNPredict), which can store an arbitrary user-defined function (UDF) and metadata to allow the user to define a leaf-node prediction function. In particular, according to some embodiments, a decision tree model file format allows named arbitrary vectors, matrices, lists, scalars, tables, sparse matrices, and sparse vectors to be stored in every leaf and non-leaf node. In such a decision tree model, a user could define a prediction function that is stored in the model.

As used herein, a decision tree ensemble may comprise a plurality of decision trees is used in an ensemble method to learn a target function and combine individual predictions of the decision tree classifiers to obtain a new prediction. A decision tree ensemble may work by learning a plurality of decision trees on training data, such as a training data set, which may include a plurality of data rows. A single decision tree may exhibit high variance on its predictions. An example decision tree ensemble may be one constructed in accordance with the RANDOM FORESTS® algorithm proposed by Leo Breiman. According to the RANDOM FOREST® algorithm, the decision tree ensemble can comprise multiple decision trees that can be trained, and each decision tree may be learned on a bootstrapped sample of the data training rows or learned by exploring a subset of features at each level of a tree during training to decorrelate the trees, thereby reducing the variance and improving accuracy of the decision tree ensemble.

For some embodiments, the process of prediction by a decision tree ensemble can involve running a DTPredict procedure on each decision tree in a plurality of decision trees, and updating a plurality of ballots based on the outputs from running DTPredict on each decision tree. The final ballot can be used to make a prediction. For this description, the foregoing decision tree process may hereafter be referred to as a Decision Tree Ensemble Prediction (DTEPredict) procedure. Confidence thresholds can be used to predict in a way that makes a trade-off between false positives and false negatives.

For classification models, each traditional decision tree in a decision tree ensemble may vote for one or more labels and give each label a weight between 0 and 1. The votes for a decision tree's output on a single tree may equal to 1 (e.g., carrot=0.1, zucchini=0.4, cucumber=0.4, greenchile=0.05, orange=0.05). The ballots among the decision trees in the decision tree ensemble may be summed so that the total votes for a single label is between 0 and T where T is the number of decision trees.

For regression models, each decision tree in a decision tree ensemble can output a real value between −infinity and infinity. The mean vote among all the decision trees in the decision tree ensemble may be taken as the prediction vote of the decision tree ensemble.

ML models described herein can be evaluated on sequestered data sets called “validation sets,” which comprise data sets not seen during training of the ML models. Depending on the embodiment, a diagnostic procedure, such as one described below, may be used to evaluate a ML model on a validation set.

One example diagnostic procedure comprises Multi-Class AUC Diagnostic (AUCDiag), which can calculate an AUC (area under the Receiver Operating Characteristic (ROC)) statistic for a ML model, such as a decision tree. An AUC statistic may be used to assess the quality of a classification model for predicting a specific class L. The ROC curve for a class L can represent a total detection rate (e.g., % of vectors with a true label L detected as L) on one axis and the false positive rate (e.g., % of vectors predicted L with a true label that is not L). The AUC statistic can be computed for every class.

Another example diagnostic procedure comprises Mean-Squared Error (MSEDiag), which can calculate a mean-squared error statistic for a ML model. MSEDiag can be used to assess the quality of a regression model. A mean-squared error statistic can provide the average squared error of a residuals. The residual may be the square of the difference between a true label and the regression output across a collection of new input vectors.

Another example diagnostic procedure comprises R-Squared (RSDiag), which can calculate a R-squared statistic for a ML model. A R-squared statistic may be used to assess the quality of a regression decision tree ensemble. For instance, where S is the sum of the square of the difference between each label and the mean label, and T is the sum of the square of the difference between each prediction and the mean label, then the R-squared static may comprise 1−T/S.

A decision tree may only store prediction metadata in leaf nodes. For a validation decision tree of some embodiments, each leaf node of the validation decision tree embeds metadata that can be used to make a prediction at the leaf node, and each non-leaf node of the validation decision tree can also embed metadata that can be used to make a prediction at the non-leaf node. Depending on the embodiment, there may be at least two kinds of metadata that may be available for embedding within a non-leaf node or leaf node of the validation decision tree: raw prediction metadata and an empirical class distribution.

Various embodiments described herein implement a validation decision tree that comprises a special decision tree for greatly accelerate tuning hyperparameters used to build or train another decision tree, which may be a traditional decision tree. In particular, some embodiments use a validation decision tree or a validation decision tree ensemble to evaluate a space of parameters (e.g., collapsible parameters) without retraining. As noted herein, an embodiment may be used as an adjunct of other methods to optimize the other decision tree parameters within a hyperparameter vector. Additionally, a validation decision tree ensemble may comprise multiple validation decision trees, which vote together on predictions. In a node histograms variant of a validation decision tree ensemble, a histogram of proportions of each label of training input vectors that fell into a node are stored.

According to some embodiments, a validation decision tree is used to evaluate and optimize one or more collapsible parameters, such as those listed in Table 1 below. For other parameters, such as hard parameters, any other technique, such as brute force and monte carlo methods may be used to optimize such other parameters. For some embodiments, the validation decision tree comprises a full and complete tree with node_size set to one (node_size=1), max_depth set to infinity (max_depth=infinity), and node_histograms set to true (node_histograms=True). This validation decision tree may store the empirical class distribution in every node, which represents the proportion of each label over all training vectors that fall into that node.

TABLE 1

| | |
|---|---|
| max_depth | This parameter determines a maximum |
| | number of edges between a root node and |
| | a leaf node when applying a decision |
| | prediction procedure. Smaller parameters |
| | may not improve accuracy, but can greatly |
| | improve prediction time. |
| node_size | This parameter determines a minimum |
| | number of input vectors that fall into a |
| | node for it to be considered non-terminal. |
| | The value may range from 1 to infinity. |
| num_trees | This parameter determines a number of |
| | decision trees in the ensemble. The value |
| | may range from 1 to infinity. For some |
| | embodiments, decision trees are added to |
| | the ensemble to reduce the overall |
| | variance in and improve prediction |
| | accuracy of the ensemble. After enough |
| | decision trees are added to the ensemble, |
| | prediction accuracy may not improve or |
| | improve all that much, but prediction time |
| | may increase increases because there |
| | more decision trees to evaluate at |
| | prediction time. |
| node_histograms | This parameter determines whether to use |
| | NHPredict, as described herein, as the |
| | leaf-node prediction procedure. The value |
| | may be True or False. |

Some embodiments explore a space of hyperparameters and output model statistics for each hyperparameter tried. Depending on the problem and needs, an embodiment may output, for example, model quality diagnostics, computation time, or memory usage for every hyperparameter tried. An embodiment may also search over depth cut offs, node size, number of trees, or node histograms without needing to retrain.

The inputs to an embodiment may comprise a range of values to explore one or more of collapsible parameters. Examples inputs can include, without limitation, those listed in Table 2 below. Other input can include, for example, a list of hard sub-hyperparameters try_H and a list of non-controlling parameters B.

TABLE 2

| | |
|---|---|
| try_max_depth | This input comprises a sorted list of |
| | unique, positive integers to try for the |
| | max_depth parameter. |
| try_node_size | This input comprises a sorted list of |
| | unique, positive integers to try for the |
| | node_size parameter. |
| try_num_trees | This input comprises a sorted list of |
| | unique, positive integers to try for the |
| | num_trees parameter |
| try_node_histograms | This input comprises a list of unique |
| | booleans to try for the node_histograms |
| | parameter. Through this, an individual |
| | may compare the accuracy of CLNPredict |
| | and NHPredict by setting |
| | try_node_histograms to list [False, True] |
| | accordingly. Where an individual wants |
| | to explore only NHPredict, |
| | try_node_histograms can be set to [True]. |
| | Where an individual wants to only use |
| | classical prediction (e.g., 1 vote per |
| | decision tree for 1 label), |
| | try_node_histograms can be set to [False]. |

Some embodiments provide a Validation decision tree Ensemble Learning (VTLearn) procedure that generates a validation decision tree by learning a decision tree using a learning algorithm, such as one based on the C4.5 algorithm by Ross Quinlan. According to some embodiments, a validation decision tree ensemble is generated and VTLearn is used to generate each validation decision tree in the validation decision tree ensemble. Depending on the embodiment, there may be two approaches for building a validation decision tree. In a first approach, a full validation decision tree with node_size=1 may be natively built, which may result in a very big tree that can only be partially used for the parameter exploration, especially if the value of try_node_size represents a large node size. A second, optional approach may reduce metadata stored in a validation decision tree so that less memory is required.

The C4.5 algorithm is traditionally used to generate a decision tree. However, unlike traditional decision tree learning, where prediction metadata is only stored in leaf nodes, the learning algorithm of an embodiment (e.g., VTLearn) generates a validation decision tree that may store prediction metadata in either or both of leaf nodes and non-leaf nodes. In particular, various embodiments store the metadata for in leaf nodes, non-leaf nodes, or both, and explore parameters that govern how big the tree should be (e.g., depth, NHPredict/CLNPredict). As such, such embodiments treat non-leaf nodes as if they were leaf nodes to assess the accuracy, and possibly other criteria. As noted herein, validation decision trees are unlike traditional decision trees, which may only store prediction metadata in leaf nodes.

The learning algorithm of an embodiment may be based on the C4.5 algorithm and can store storing prediction metadata in a non-leaf node based on one or both of the following criteria.

Criteria 1: Prediction metadata is stored in a non-leaf node if any of the following criteria is met: (a) if a non-leaf node's depth is less than or equal to the maximum value in try_max_depth; or (b) if the number of training rows that enter the node is at least the minimum value in try_node_size.
Criteria 2: Criteria for determining what prediction metadata to store in a non-leaf node or leaf node: (a) if True is in the list try_node_histograms and the model is for classification, store the prediction metadata corresponding to the NHPredict procedure storage efficiency; (b) if True is in the list try_node_histograms and the model is for regression, throw an error; and (c) if False is in the list try_node_histograms and the model is for classification, store the prediction metadata corresponding to the CLNPredict procedure described herein for classification and the prediction metadata corresponding to RPredict for regression.
For some embodiments, both criteria need to be satisfied for prediction metadata to be stored in a non-leaf node.

Some embodiments provide a Validation decision tree Ensemble Prediction Procedure (VTEPredict) procedure that comprises an ensemble prediction procedure for a validation decision tree ensemble. For some embodiments, the VTEPredict procedure is similar to the DTEPredict procedure described herein and uses up to num_trees validation decision trees in the validation decision tree ensemble.

Some embodiments provide a Validation decision tree Prediction Procedure (VTPredict) procedure that comprises a prediction procedure for a validation decision tree. For some embodiments, VTPredict is similar to DTPredict (described herein) but stops based on different criteria than DTPredict. For instance, assume N is the current working node in VTPredict's traversal of a validation decision tree. If the depth of the current working node is equal to max_depth or if the number of training rows in the training set that fell into the current working node is less than node_size, then VTPredict may stop the traversal and predict using the current working node's prediction metadata. According to some embodiments, the current working node of the validation decision tree comprises at least one of a non-leaf node or a leaf node. This may be dissimilar from DTPredict, where only leaf nodes may include prediction metadata. Additionally, if node_histograms is True for the validation decision tree being traversed, NHPredict may be used as a node prediction procedure. Otherwise, if node_histograms is False for the validation decision tree being traversed, CLNPredict may be used for classification and RPredict may be used for regression, except when the static parameters in B or hard parameters in H specify a different node prediction procedure. B may represent a vector of parameters (e.g., 40 to 50 parameters) that are fixed and for which different values are not explored. H may represent a vector of hard parameters comprising collapsible parameters and non-collapsible parameters. Collapsible parameters may use validation decision trees for exploring the best values for collapsible so that retrains are not required or to reduce the number of model retrains required. Non-collapsible parameters may be parameters that do not use validation decision trees for hyperparameter exploration (e.g. the splitting criterion, the mtry feature column sampling proportion, etc.). H and B may be sub-vectors that can be concatenated into a single vector of parameters.

Some embodiments provide a Model Hyperparameter Exploration Procedure (VTParamExplore) procedure to explore hyperparameters of a ML model using a validation decision tree ensemble. As noted herein, various embodiments build more than one validation decision tree to be able to explore parameters values, such as the num_trees parameter. VTExploreParam may loop over a set of hard parameters in try_H. Additionally, VTExploreParam may train a new ensemble of validation decision trees using VTLearn and based on the training data set training_set, which can result in a new validation decision tree ensemble model. VTExploreParam may then loop over the collapsible parameters in a telescoping fashion, calling VTEPredict on the newly generated validation decision tree ensemble model. According to some embodiments, the telescoping fashion involves several inner operation loops in VTEPredict, where the first inner loops are for parameters that are non-collapsible parameters, which may require retrains for each value tried, and inner-most loops that are for collapsible parameters (e.g., node_size, num_trees, node_histograms, and max_depth). For each VTEPredict call, diagnostics may be recorded, such as statistical diagnostics, memory usage, and performance. Subsequently, VTExploreParam may append a row to a tuning table for a ML model, where the tuning table may include one or more of a set of collapsible parameters, a set of hard parameters, and diagnostics information.

Reference will now be made in detail to embodiments of the present disclosure, examples of which are illustrated in the appended drawings. The present disclosure may, however, be embodied in many different forms and should not be construed as being limited to the embodiments set forth herein.

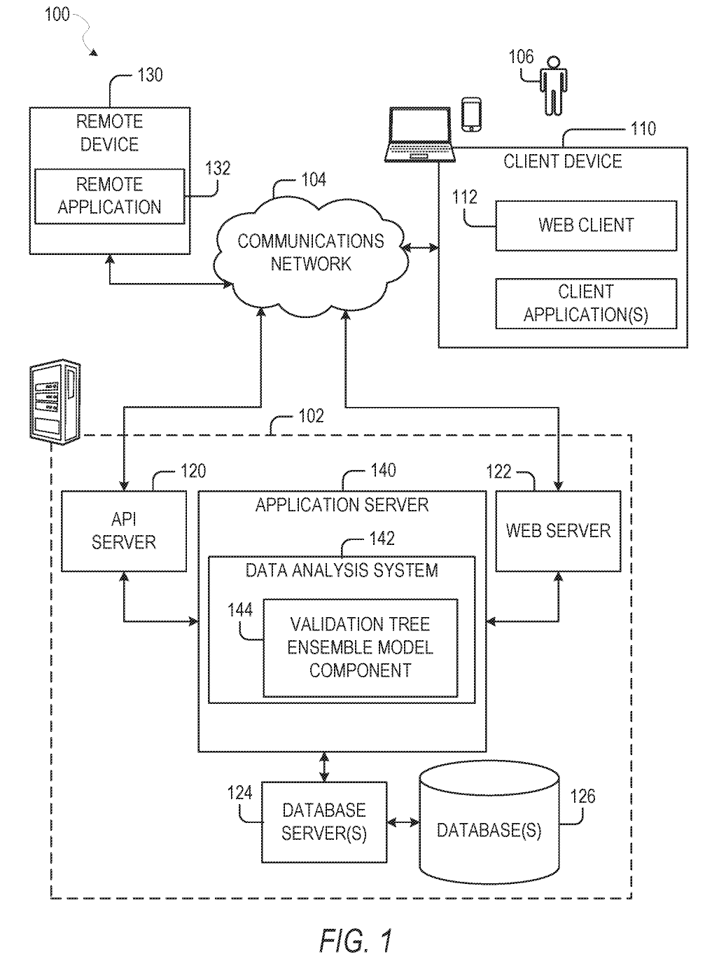

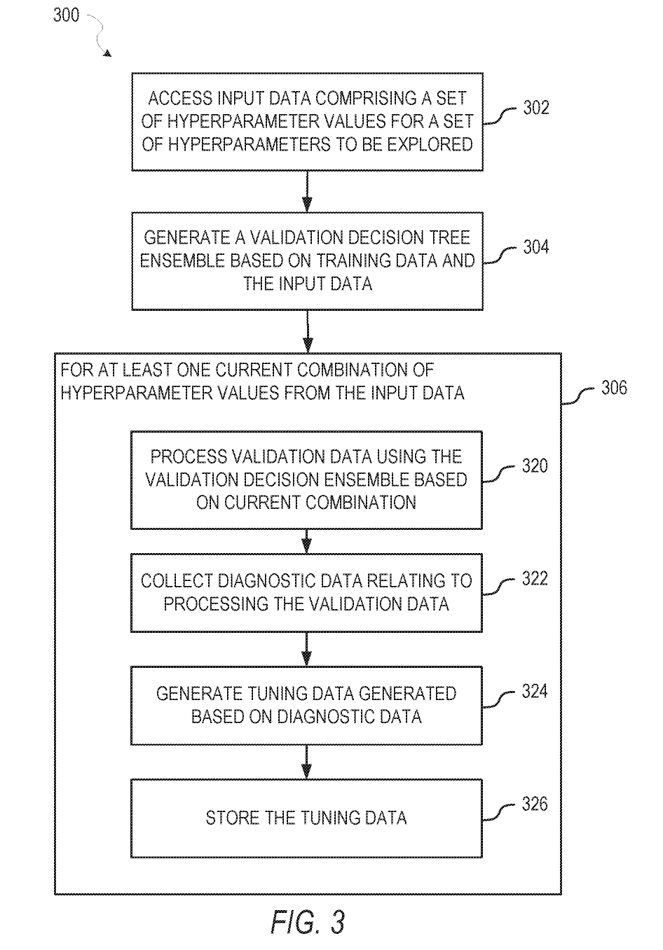

FIG. 1 is a block diagram illustrating an example networked system 102 including a validation decision tree ensemble model component 144, in accordance with some embodiments of the present disclosure. According to some embodiments, the validation decision tree ensemble model component 144 is used to generate or use a validation decision tree ensemble to explore a set of hyperparameter values. The validation decision tree ensemble may incorporate model statistics for each hyperparameter explored in the set of hyperparameter values. The validation decision tree ensemble model component 144 may operate in accordance with one or more embodiments described with respect to FIGS. 3-5.

With reference to FIG. 1, an embodiment of a high-level client-server-based network architecture 100 is shown. As shown, the network architecture 100 includes the networked system 102, a client device 110, one or more remote devices 130, and a communications network 104 facilitating data communication therebetween. The networked system 102 provides server-side data analysis functionality, via the communications network 104, to one or more client devices 110. FIG. 1 illustrates, for example, a web client 112, such as a web browser, and a client application 114 executing on the client device 110.

As also shown, the networked system 102 includes a data analysis system 142 comprising the validation decision tree ensemble model component 144. The data analysis system 142 may use the validation decision tree ensemble model component 144 to generate or use a validation decision tree, which in turn can be used to build or train a decision tree ensemble used to analyze data from industrial devices, such as generators, wind turbines, medical devices, jet engines, and locomotives. By way of the data analysis system 142, the networked system 102 can form an industrial device data analysis software platform. This industrial device data analysis software platform can include a collection of software services and software development tools, which enable a user (e.g., an industrial customer) to use, or develop and use, applications for optimizing industrial business processes with respect to industrial devices.

In FIG. 1, the remote device 130 may represent an industrial device that includes a remote application 132 to collect data from the remote device 130, such as sensor data, diagnostic data, or performance data. The collected data may comprise event logs, error logs, time-series data, and the like. The collected data may be included by input data (e.g., input feature vector) to a decision tree ensemble that is built or trained through the assistance of the validation decision tree ensemble model component 144.

The client device 110 may comprise, but is not limited to, a mobile phone, desktop computer, laptop, portable digital assistant (PDA), smart phone, tablet, ultrabook, netbook, laptop, multi-processor system, microprocessor-based or programmable consumer electronics system, game console, set-top box (STB), or any other communication device that a user may utilize to access the networked system 102. In some embodiments, the client device 110 comprises a display module (not shown) to display information, such as in the form of user interfaces. In further embodiments, the client device 110 comprises one or more touch screens, accelerometers, gyroscopes, cameras, microphones, global positioning system (GPS) devices, and so forth. The client device 110 may be a device of a user that is used to access data analysis or industrial applications supported by the networked system 102. One or more users 106 may be a person, a machine, or other means of interacting with the client device 110. In embodiments, the user 106 is not part of the network architecture 100, but interacts with the network architecture 100 via the client device 110 or another means. For example, one or more portions of the communications network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi® network, a WiMax network, another type of network, or a combination of two or more such networks.

The client device 110 may include one or more applications such as, but not limited to, a business or industrial application supported by the data analysis system 142. In some embodiments, the business or industrial application is included in one of the client devices 110, and the application is configured to locally provide the user interface and at least some of the functionalities to communicate with the networked system 102, on an as-needed basis, for data or processing capabilities not locally available. Conversely, in some embodiments, the business or industrial application is not included in the client device 110, and the client device 110 may use its web browser to access the business or industrial application (or a variant thereof) hosted on the networked system 102.

As noted herein, in embodiments, the user 106 is not part of the network architecture 100, but may interact with the network architecture 100 via the client device 110 or other means. For instance, the user 106 provides input to the client device 110 and the input is communicated to the networked system 102 via the communications network 104. In this instance, the networked system 102, in response to receiving the input from the user 106, communicates information to the client device 110 via the communications network 104 to be presented to the user 106. In this way, the user 106 can interact with the networked system 102 using the client device 110.

An application programming interface (API) server 120 and a web server 122 are coupled to, and provide programmatic and web interfaces respectively to, one or more application servers 140. As shown, the application server 140 hosts the data analysis system 142, which, in addition to the validation decision tree ensemble model component 144, may include one or more additional modules, each of which may be embodied as hardware, software, firmware, or some combination thereof.

The application server 140 is shown to be coupled to one or more database servers 124 that facilitate access to one or more information storage repositories or databases 126. In an embodiment, the databases 126 are storage devices that store information, such as data generated and collected from an industrial device to be analyzed by the data analysis system 142.

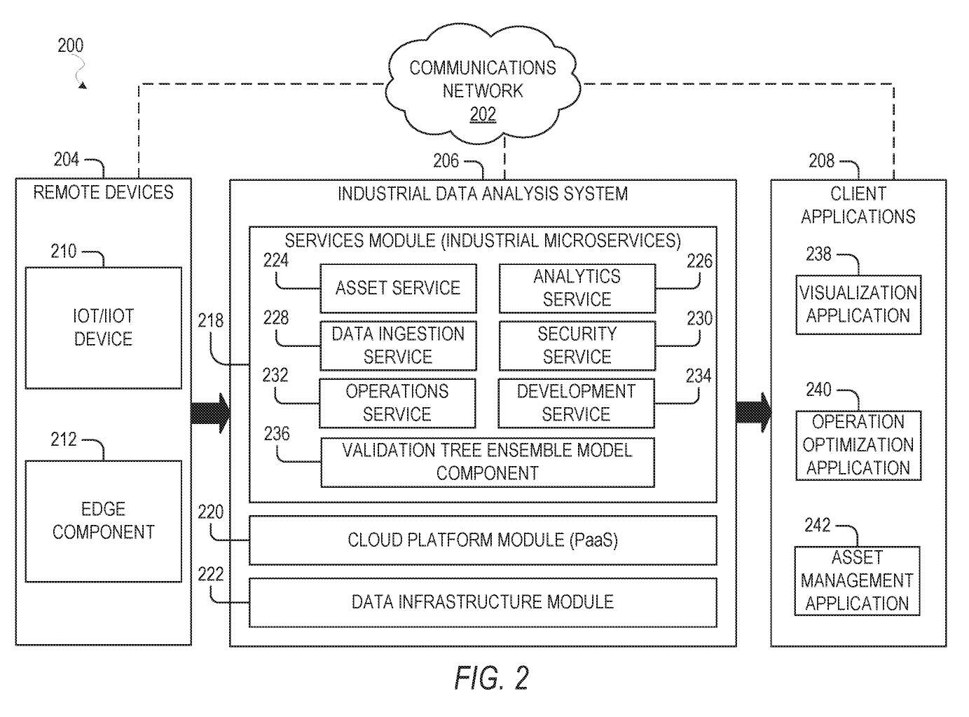

FIG. 2 is a block diagram illustrating an example system 200 including a validation decision tree ensemble model component 236, in accordance with some embodiments. As shown, the system 200 includes remote devices 204, an industrial data analysis system 206, one or more client applications 208, and a communications network 202 to facilitate data communication therebetween. The remote devices 204 can represent any device that can collect data regarding itself and provide the collected data to the industrial data analysis system 206 to perform analysis and other operations. The collected data may comprise event logs, error logs, time-series data, and the like. As shown, the remote devices 204 include an IoT or Industrial IoT (IIoT) device 210 and an edge component 212, such as an IoT/IIoT gateway, device controller, or sensor node.

For some embodiments, the industrial data analysis system 206 represents a machine-learning, data analysis platform, such as Predix®, which may use the validation decision tree ensemble model component 236 to assist in generating a decision tree ensemble. The decision tree ensemble may process a set of feature values based on, regarding, or including data provided by the remote device 204, such as device make, device model, event logs, error logs, and time-series data. The client applications 208 may represent those applications that use functions of, or data results generated by, the industrial data analysis system 206. As shown, the client applications 208 include a visualization application 238, an operation optimization application 240, and an asset management application 242, such as an industrial device software application.

For some embodiments, the validation decision tree ensemble model component 236 is to explore a plurality of potential values for one or more hyperparameters for building a IIoT ML model used to process and analyze data (e.g., event logs, error logs, and time-series data) generated by an IIoT device (e.g., the remote device 204), such as a wind turbine. The plurality of potential values may be ones provided by an individual (e.g., a software/ML model engineer or data scientist) who may be assisting or otherwise facilitating the generation of the IIoT ML model for use (e.g., by the industrial data analysis system 206). The validation decision tree ensemble model component 236 may ingest the plurality of potential values (e.g., corresponding to different hyperparameters), generate a validation decision tree ensemble based on training data for the IIoT ML model and the plurality of potential values, generate tuning data based on the validation decision tree ensemble (where the tuning data describes performance of the validation decision tree ensemble), and using the tuning data to generate a decision tree ensemble as the IIoT ML model. Once generated based on the tuning data, the IIoT ML model can process, for instance, diagnostic data generated by an IIoT device (e.g., wind turbine) and generate prediction data for the IIoT data based on the diagnostic data. The prediction data generated by the decision tree ensemble of the IIoT ML model can be subsequently used by the industrial data analysis system 206 to perform subsequent actions (e.g., automatically shutting down the wind turbine or ordering preventative maintenance upon the IIoT ML model predicting equipment failure).

The industrial data analysis system 206 includes a services module 218, a cloud platform module 220, and a data infrastructure module 222. The industrial data analysis system 206 can include a collection of software services and software development tools, which enable a user (e.g., an industrial customer) to use, or develop and use, applications for optimizing industrial business processes with respect to industrial devices. For instance, the industrial data analysis system 206 can monitor IIoT devices, digest data from such devices, analyze the digested data using services (e.g., microservices) provided by the services module 218, and make predictions using machine-learning (ML) implemented by one or more services of the services module 218.

The services module 218 can provide various industrial services that a development user can use to build an industrial software application or pre-built software services (e.g., from a third-party vendor). As shown, the services module 218 includes an asset service 224, an analytics service 226, a data ingestion service 228, a security service 230, an operations service 232, a development service 234, and the validation decision tree ensemble model component 236. The asset service 224 may facilitate creation, importation, and organization of industrial device/asset models and associated business rules. The analytics service 226 may facilitate creation, cataloging, or orchestration of analytics on industrial devices, which can serve as a basis for industrial applications, such as the client applications 208. The data ingestion service 228 can facilitate ingestion, formatting, merging, or storage of data from an industrial device. The security service 230 may facilitate end-to-end security, authentication, or authorization between the industrial data analysis system 206 and other entities within the system 200. The operations service 232 may facilitate control and operation of industrial devices. The development service 234 may facilitate the development of industrial applications, by a development user, using the industrial data analysis system 206.

The cloud platform module 220 may comprise a cloud framework that enables various functions of the industrial data analysis system 206 to be built, or operated, as cloud-based services, such as a platform-as-a-service (PaaS).

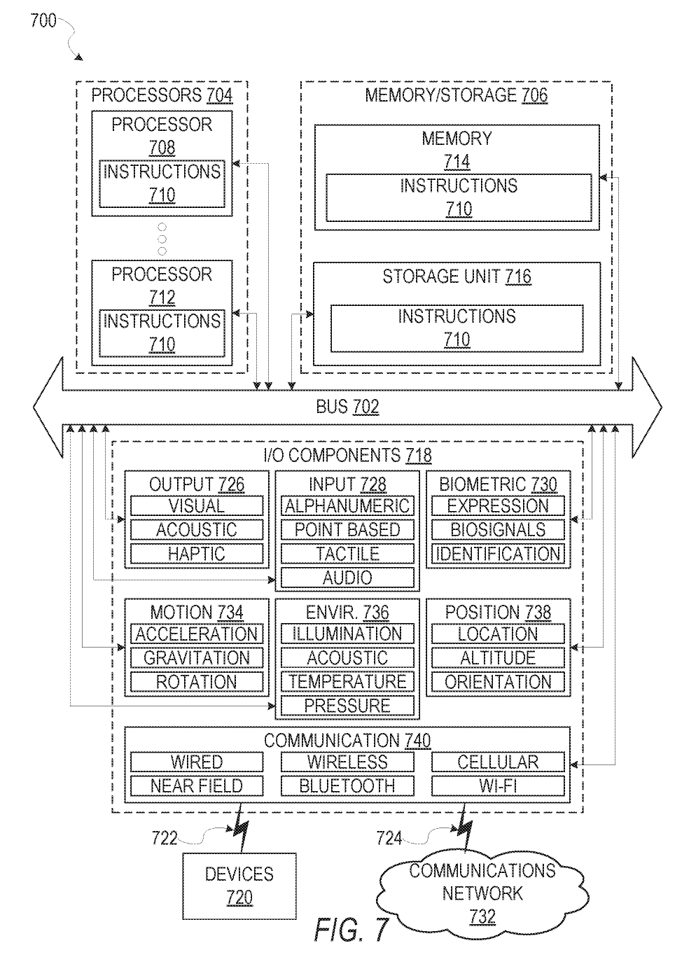

FIG. 3 is a flowchart illustrating an example method 300 for a validation decision tree ensemble, according to some embodiments. In particular, the method 300 may be used to generate and use a validation decision tree ensemble to explore a set of hyperparameters for a machine learning (ML) model, such as a decision tree. For some embodiments, operations of the method 300 are performed by a machine or a system described herein, such as a machine 700 described herein with respect to FIG. 7, the data analysis system 142 described herein with respect to FIG. 1, or the industrial data analysis system 206 described herein with respect to FIG. 2. An operation of the method 300 may be performed by a hardware processor, such as a central processing unit (CPU) or graphics processing unit (GPU), of a computing device, such as a desktop, laptop, server, or the like. Though the operations of the method 300 is depicted and described in a certain order, the order in which the operations are performed may vary among embodiments, including performing certain operations in parallel.

As shown in FIG. 3, the method 300 begins with operation 302 accessing input data comprising a set of hyperparameter values for each hyperparameter, in a set of hyperparameters, to be explored for training a decision tree ensemble. As noted herein, the set of hyperparameters may include a collapsible hyperparameter to be explored for training the decision tree. For example, the set of hyperparameters may include the max_depth hyperparameter, and the input data may comprise a set of hyperparameter values (e.g., values ranging from 1 to infinity) to be explored for the max_depth hyperparameter. As another example, the set of hyperparameters may include the node_size hyperparameter, and the input data may comprise a set of hyperparameter values (e.g., values ranging from 1 to infinity) to be explored for the node_size hyperparameter. As another example, the set of hyperparameters may include the num_trees hyperparameter, and the input data may comprise a set of hyperparameter values (e.g., values ranging from 1 to infinity) to be explored for the num_trees hyperparameter. As another example, the set of hyperparameters may include the node_histograms hyperparameter, and the input data may comprise a set of hyperparameter values (e.g., value of true or false) to be explored for the node_histograms hyperparameter. The input data may be accessed from a file or database, which may contain one or more hyperparameter values defined by a user for hyperparameter exploration.

The method 300 continues with operation 304 generating a validation decision tree ensemble based on training data and the input data accessed by operation 302. The training data may comprise at least some data intended to be used in training the decision tree for which one or more hyperparameter values are being explored by the method 300. For some embodiments, the validation decision tree ensemble is generated (e.g., learned) by generating one or more validation decision trees (e.g., all the validation decision trees), of the validation decision tree ensemble, using a procedure similar to the VTLearn procedure described herein.

For some embodiments, generating a validation decision tree for the validation decision tree ensemble comprises storing prediction metadata in a non-leaf node of the validation decision tree in response to the non-leaf node satisfying a set of prediction data storage criteria based on the input data. For example, the prediction data storage criteria may include a criterion that a depth of the non-leaf node within the validation decision tree is less than or equal to a maximum value found in the set of hyperparameter values corresponding to a hyperparameter, in the set of hyperparameters, relating to a maximum number of edges between a root node of the validation decision tree and a leaf node of the validation decision tree, such as the max_depth hyperparameter. As another example, the prediction data storage criteria may include a criterion that a size of the non-leaf node is at least greater than or equal to a minimum value found in the set of hyperparameter values that corresponds to a hyperparameter, in the set of hyperparameters, relating to a minimum size of a non-leaf node, such as the node_size hyperparameter. The size of the non-leaf node may be reflected by the number of rows from the training data that enter the non-leaf node.

For some embodiments, storing the prediction metadata in a non-leaf node or a leaf node of the validation decision tree comprises determining what prediction metadata is stored in the non-leaf node or the leaf node of the validation decision tree. For example, storing the prediction metadata in the non-leaf node of the validation decision tree comprises determining a value, in the set of hyperparameter values, that corresponds to a hyperparameter, in the set of hyperparameters, relating to whether a node histogram (e.g., NHPredict procedure) is used for a prediction by the validation decision tree ensemble. In response to determining that the value is true, an empirical class distribution associated with the prediction data may be stored in the non-leaf node or the leaf node. Storage of the empirical class distribution may be facilitated using a sparse vector for computing efficiency. In response to determining that the value is not true (e.g., false), raw prediction data may be stored in the non-leaf node or the leaf node.

The method 300 continues operation 306, where operations 320 through 326 are performed for at least one combination of hyperparameter values, from the input data accessed by operation 302, corresponding to the set of hyperparameters. For some embodiments, operations 320 through 326 are performed for each combination of hyperparameter values. A particular combination of hyperparameter values, from the input data, may be represented by a vector.

Within operation 306, the method 300 begins with operation 320 processing validation data using the validation decision tree ensemble based on the at least one current combination of hyperparameter values. The validation data may comprise data different from the training data used by operation 304 (e.g., data not seen by the validation decision tree ensemble during generation). The validation data may be used to evaluate the performance (e.g., speed, accuracy, etc.) of a validation decision tree or a validation decision tree ensemble.

Within operation 306, the method 300 continues with operation 322 collecting diagnostic data relating to the processing the validation data. Collection of the diagnostic data may be performed by operation 322 concurrent or subsequent to operation 320. The diagnostic data may comprise information relating to at least one of accuracy of the validation decision tree ensemble, statistical diagnostic of the validation decision tree ensemble, memory usage by the validation decision tree ensemble, or performance of the validation decision tree ensemble. Example procedures used to collect the diagnostic information can include, without limitation: Multi-Class AUC Diagnostic (AUCDiag), which can calculate an AUC (area under the Receiver Operating Characteristic (ROC)) statistic for the validation decision tree ensemble; Mean-Squared Error (MSEDiag), which can calculate a mean-squared error statistic for the validation decision tree ensemble; and R-Squared (RSDiag), which can calculate a R-squared statistic for the validation decision tree ensemble.

Within operation 306, the method 300 continues with operation 324 generating tuning data based on the diagnostic data, where the tuning data describes performance of the validation decision tree ensemble based on the at least one current combination of hyperparameter values. The method 300 continues with operation 326 storing the tuning data. For some embodiments, storing the tuning data generated based on the diagnostic data comprises creating or updating (e.g., appending) a tuning data table to include a row that comprises the at least one current combination of hyperparameter values and information from the diagnostic data. The tuning data table may be subsequently used to provide one or more hyperparameter values for building or training a decision tree ensemble, such as one or more hyperparameter values optimal for achieving a desired performance by the decision tree ensemble. In this way, the tuning data table can provide hyperparameter values that permit a user to tune the performance or operation of a decision tree ensemble. The tuning data table may be part of a file or a database.

For some embodiments, the method 300 is performed for each set of hyperparameter values for a second set of hyperparameters, where the second set of hyperparameters is mutually exclusive from the (first) set of hyperparameters considered by operations 304 through 326. For example, while the (first) set of hyperparameters may only include one or more collapsible parameters, the second set of hyperparameters may only include one or more non-collapsible parameters of the decision tree, such as a hard parameter of the decision tree.

At the conclusion of the method 300, a particular set of hyperparameter values (e.g., a particular vector) may be obtained from the tuning data table, and a decision tree ensemble may be generated based on training data, which may comprise second training data that is different from the training data used by operation 304. The decision tree ensemble generated may be used to process second input data, which may produce output data comprising prediction information based on the second input data. For some embodiments, the second input data is based on device data received from an Industrial Internet-of-Things (IIoT) device.

In the context of an IIoT application, the validation decision tree ensemble model component 236 performs the method 300 according to some embodiments. For example, at operation 302, the validation decision tree ensemble model component 236 can access input data comprising a set of hyperparameter values (e.g., try_max_depth={3, 6, 8, 9, 11}, try_node_size={2, 5, 8}, try_num_trees={2, 5, 10, 12}, try_node_histogram={True, False}), for a set of hyperparameters (e.g., max_depth, node_size, num_trees, node_histogram), to be explored for training a decision tree ensemble of an IIoT ML model for predicting failure of a gas turbine engine.

At operation 304, the validation decision tree ensemble model component 236 can generate a validation decision tree ensemble based on training data and the input data accessed by the validation decision tree ensemble model component 236 at operation 302. The training date may comprise historical diagnostic data (e.g., time series data) generated by the gas turbine engine and corresponding outcome data (e.g., time series data) indicating whether a failure condition exists for the gas turbine engine.

At operation 306, the validation decision tree ensemble model component 236 can perform operations 320 through 326 for one or more combinations of hyperparameters values possible from the set of hyperparameter values (e.g., (max_depth, node_size, num_trees, node_histogram]={(3, 2, 2, True}, {6, 2, 2, True}, {6, 2, 2, True}, {8, 2, 2, True}, . . . {11, 8, 12, False}}).

At operation 320, the validation decision tree ensemble model component 236 can cause validation data to be processed by the validation decision tree ensemble, generated at operation 304, based on a current combination of hyperparameters values for the set of hyperparameter values (e.g., (max_depth, node_size, num_trees, node_histogram]={3, 2, 2, True}). Like the training data, the validation data may comprise historical diagnostic data (e.g., time series data) generated by the gas turbine engine and corresponding outcome data (e.g., time series data) indicating whether a failure condition exists for the gas turbine engine. For some embodiments, the validation data and the training data comprise different data sets.

At operation 322, the validation decision tree ensemble model component 236 can collect diagnostic data relating to the processing the validation data, by the validation decision tree ensemble, at operation 320. As noted herein, the diagnostic data may comprise information relating to at least one of accuracy of the validation decision tree ensemble, statistical diagnostic of the validation decision tree ensemble, memory usage by the validation decision tree ensemble, and performance of the validation decision tree ensemble as the validation decision tree ensemble processes the validation data for the gas turbine engine.

At operation 324, the validation decision tree ensemble model component 236 can generate tuning data, based on the diagnostic data collected at operation 322, such that the tuning data describes performance of the validation decision tree ensemble based on the current combination of hyperparameters values being used (by operation 320) for the set of hyperparameter values (e.g., {max_depth, node_size, num_trees, node_histogram]={3, 2, 2, True}).

At operation 326, the validation decision tree ensemble model component 236 can store the tuning data, generated at operation 324, in a tuning table or database, which may include a row comprising the current combination of hyperparameter values being used (by operation 320) and information from the diagnostic data collected at operation 322. After performing one or more iterations of operations 320-326 for various combinations of hyperparameter values, a particular combination of hyperparameter values (e.g., {max_depth, node_size, num_trees, node_histogram]={6, 2, 2, False}) can be identified based on corresponding diagnostic data that indicates optimal performance and accuracy achieved by the validation decision tree ensemble. Subsequently, the decision tree ensemble for the IIoT ML model may be generated using the particular combination of hyperparameter values identified from the tuning table/database.

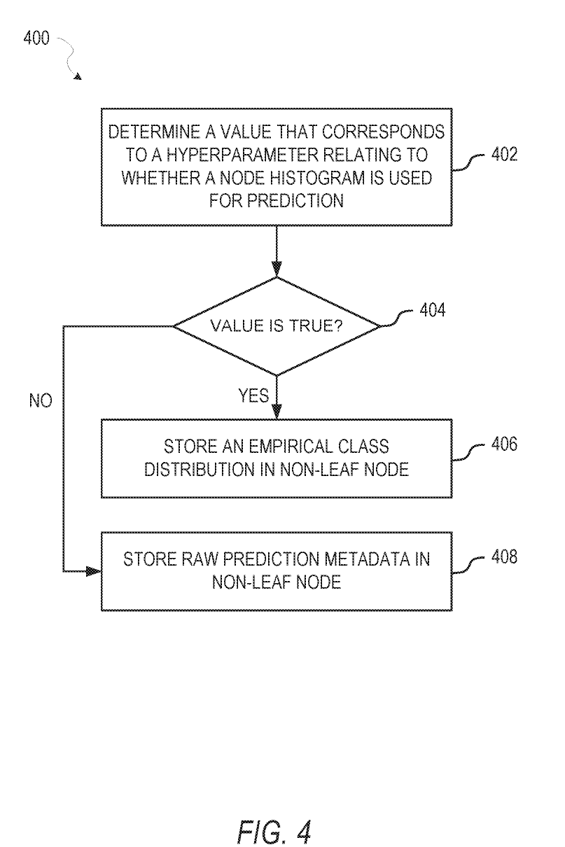

FIG. 4 is a flowchart illustrating an example method 400 for generating a validation decision tree, according to some embodiments. In particular, the method 400 may be performed by an embodiment to determine if a non-leaf node of a validation decision tree stores prediction metadata. For some embodiments, the method 400 is performed as part of operation 304 of the method 300 described herein with respect to FIG. 3. For some embodiments, operations of the method 400 are performed by a machine or a system described herein. An operation of the method 400 may be performed by a hardware processor, such as a central processing unit (CPU) or graphics processing unit (GPU), of a computing device, such as a desktop, laptop, server, or the like. Though the operations of the method 400 is depicted and described in a certain order, the order in which the operations are performed may vary among embodiments, including performing certain operations in parallel.

As shown in FIG. 4, the method 400 begins with operation 402 determining a value, in the set of hyperparameter values, that corresponds to a hyperparameter, in the set of hyperparameters, relating to whether a node histogram is used for a prediction by the validation decision tree ensemble. The method 400 continues with operation 404, where if the value is true, the method 400 continues with operation 406, and if the value is not true, the method 400 continues with operation 408. Operation 406 stores an empirical class distribution associated with the prediction data in the non-leaf node or the leaf node. Operation 408 stores raw prediction data in the non-leaf node or the leaf node.

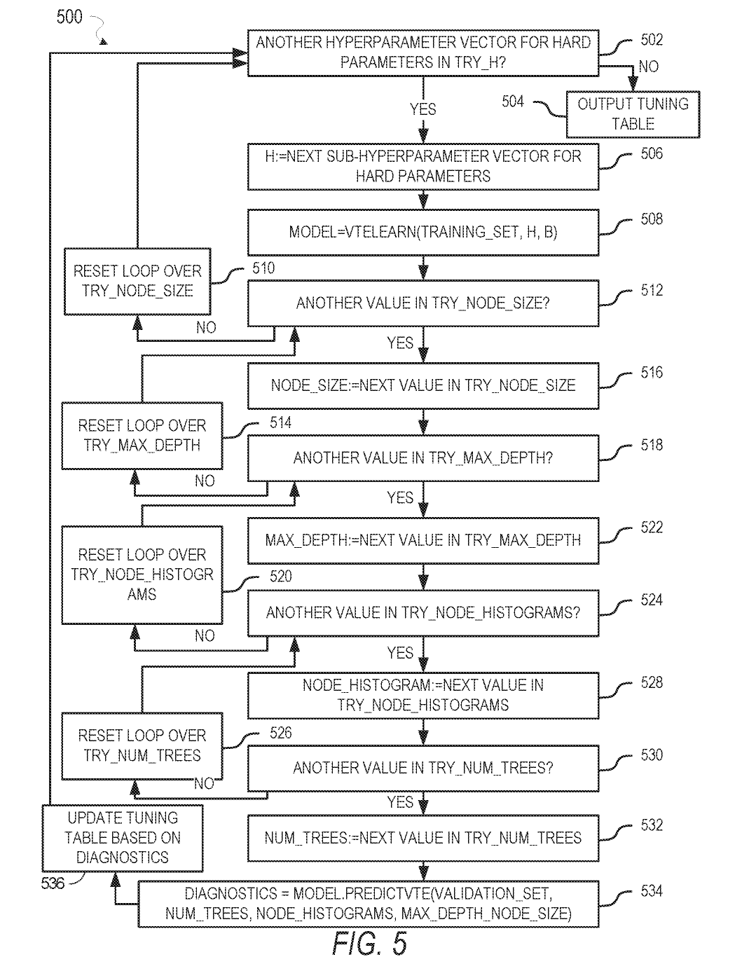

FIG. 5 is a flowchart illustrating the flow of an example method 500 for exploring a set of hyperparameters for a machine learning (ML) model, according to some embodiments. In particular, for some embodiments, VTParamExplore comprises the method 500.

In FIG. 5, the method 500 may begin with operation 502 determining whether a sub-hyperparameter vector for hard parameters exists in try_H that has yet to be considered by the method 500. If no, the method 500 continues with operation 504 outputting a tuning table for a ML model, where the tuning table includes hyperparameters determined by the method 500. If yes, the method 500 continues to operation 506, where a set of hard parameters H is set to the sub-hyperparameter vector determined at operation 502. The method 500 continues with operation 508 generating a validation decision tree ensemble (hereafter, referred to as model) using VTELearn described herein and based on at least one of a training set, a set of hard parameters H, and a set of static parameters B.

From operation 508, the method 500 continues with operation 512 determining whether a value exists in try_node_size that has yet to be considered by the method 500. If no, the method 500 continues with operation 510 resetting the loop over try_node_size, and returning to operation 502 to consider another possible sub-hyperparameter vector for hard parameters in try_H. If yes, the method 500 continues to operation 516, where node_size is set to the value determined at operation 512.

From operation 516, the method 500 continues with operation 518 determining whether a value exists in try_max_depth that has yet to be considered by the method 500. If no, the method 500 continues with operation 514 resetting the loop over try_max_depth, and returning to operation 512 to consider another possible value in try_node_size. If yes, the method 500 continues to operation 522, where max_depth is set to the value determined at operation 518.

From operation 522, the method 500 continues with operation 524 determining whether a value exists in try_node_histogram that has yet to be considered by the method 500. If no, the method 500 continues with operation 520 resetting the loop over try_node_histogram, and returning to operation 518 to consider another possible value in try_max_depth. If yes, the method 500 continues to operation 528, where node_histogram is set to the value determined at operation 524.

From operation 528, the method 500 continues with operation 530 determining whether a value exists in try_num_trees that has yet to be considered by the method 500. If no, the method 500 continues with operation 526 resetting the loop over try_num_trees, and returning to operation 524 to consider another possible value in try_node_histogram. If yes, the method 500 continues to operation 532, where num_trees is set to the value determined at operation 530.

From operation 532, the method 500 continues with operation 534 determining a set of diagnostics for the model, generated at operation 508, using VTEPredict and based on at least one of a validation set, num_trees, node_histogram, max_depth, and node_size. As described herein, num_trees, node_histogram, max_depth, and node_size may be examples of collapsible parameters. The set of diagnostics determined at operation 534 may include, for example, one or more of the following: memory usage, performance, accuracy, statistical diagnostics, and performance results.

From operation 534, the method 500 continues with operation 536 updating a tuning table for a ML model based on diagnostic determined by operation 534. For some embodiments, the updating comprises appending the tuning table with a row defined by at least one of the set of hard parameters H, num_trees, node_histogram, max_depth, node_size, and information from the set of diagnostics determined at operation 534. From operation 534, the method 500 returns to operation 502 to consider another possible sub-hyperparameter vector for hard parameters in try_H.

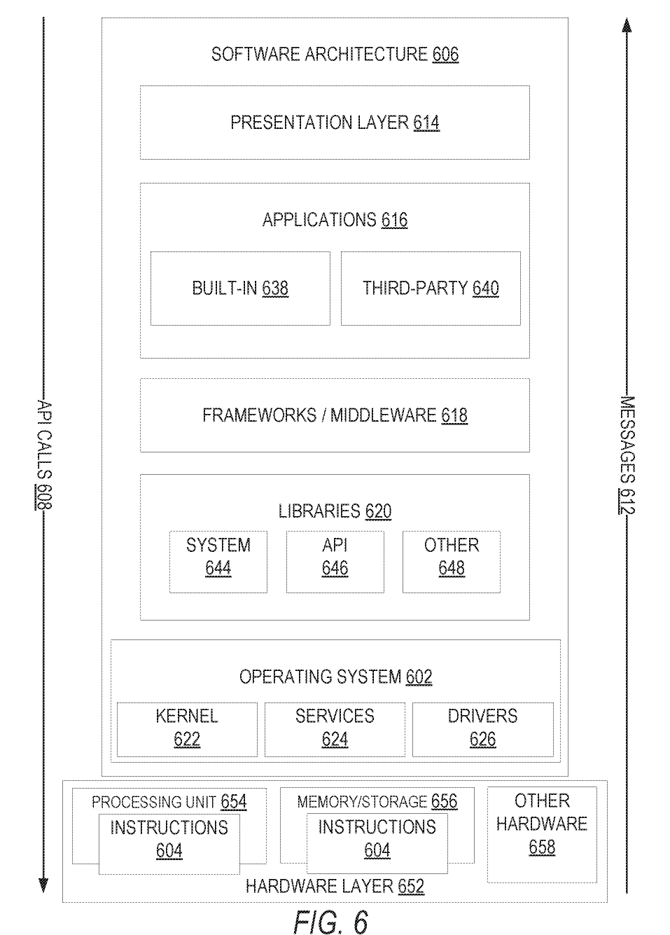

Various embodiments described herein may be implemented by way of the example software architecture illustrated by and described with respect to FIG. 6 or by way of the example machine illustrated by and described with respect to FIG. 7.

FIG. 6 is a block diagram illustrating an example software architecture 606, which may be used in conjunction with various hardware architectures herein described. FIG. 6 is a non-limiting example of a software architecture and it will be appreciated that many other architectures may be implemented to facilitate the functionality described herein. The software architecture 606 may execute on hardware such as a machine 700 of FIG. 7 that includes, among other things, processors 704, memory 714, and input/output (I/O) components 718. A representative hardware layer 652 is illustrated and can represent, for example, the machine 700 of FIG. 7. The representative hardware layer 652 includes a processing unit 654 having associated executable instructions 604. The executable instructions 604 represent the executable instructions of the software architecture 606, including implementation of the methods, components, and so forth described herein. The hardware layer 652 also includes memory and/or memory/storage modules 656, which also have the executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke API calls 608 through the software stack and receive messages 612 in response to the API calls 608. The layers illustrated are representative in nature and not all software architectures have all layers. For example, some mobile or special-purpose operating systems 602 may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than by interfacing directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 provide a higher-level common infrastructure that may be used by the applications 616 and/or other software components/modules. For example, the frameworks/middleware 618 may provide various graphic user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. The third-party applications 640 may include an application developed using the Android™ or iOS™ software development kit (SDK) by an entity other than the vendor of the particular platform, and may be mobile software running on a mobile operating system such as iOS™, Android™, Windows® Phone, or other mobile operating systems. The third-party applications 640 may invoke the API calls 608 provided by the mobile operating system (such as the operating system 602) to facilitate functionality described herein.

The applications 616 may use built-in operating system functions (e.g., kernel 622, services 624, and/or drivers 626), libraries 620, and frameworks/middleware 618 to create user interfaces to interact with users of the system. Alternatively, or additionally, in some systems, interactions with a user may occur through a presentation layer, such as the presentation layer 614. In these systems, the application/component “logic” can be separated from the aspects of the application/component that interact with a user.

FIG. 7 is a block diagram illustrating components of an example machine 700, according to some embodiments, able to read instructions 710 from a machine storage medium and perform any one or more of the methodologies discussed herein. Specifically, FIG. 7 shows a diagrammatic representation of the machine 700 in the example form of a computer system, within which the instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by that machine 700. Further, while only a single machine 700 is illustrated, the term “machine” shall also be taken to include a collection of machines 700 that individually or jointly execute the instructions 710 to perform any one or more of the methodologies discussed herein.

The machine 700 may include processors 704, memory/storage 706, and I/O components 718, which may be configured to communicate with each other such as via a bus 702. The processors 704 may comprise a single processor or, as shown, comprise multiple processors (e.g., processors 708 and 712). The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor 708's cache memory), or any suitable combination thereof, during execution thereof by the machine 700. Accordingly, the memory 714, the storage unit 716, and the memory of the processors 704 are examples of machine storage media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various embodiments, the I/O components 718 may include output components 726 and input components 728. The output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further embodiments, the I/O components 718 may include biometric components 730, motion components 734, environment components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 may include acceleration sensor components (e.g., accelerometer), gravitation sensor components, rotation sensor components (e.g., gyroscope), and so forth. The environment components 736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a communications network 732 or devices 720 via a coupling 724 and a coupling 722, respectively. For example, the communication components 740 may include a network interface component or other suitable device to interface with the communications network 732. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geolocation, location via Wi-Fi® signal triangulation, location via detecting an NFC beacon signal that may indicate a particular location, and so forth.

It will be understood that “various components” (e.g., modules) used in this context (e.g., system components) refers to a device, a physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function or related functions. Components may constitute either software components (e.g., code embodied on a machine storage medium) or hardware components. A hardware component is a tangible unit capable of performing certain operations and may be configured or arranged in a certain physical manner. In various embodiments, one or more computer systems (e.g., a standalone computer system, a client computer system, or a server computer system) or one or more hardware components of a computer system (e.g., a processor 708 or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor 708 or another programmable processor 708. Once configured by such software, hardware components become specific machines (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 708 configured by software to become a special-purpose processor, the general-purpose processor 708 may be configured as respectively different special-purpose processors (e.g., comprising different hardware components) at different times. Software accordingly configures a particular processor 708 or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor 708 or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a communications network 732 (e.g., the Internet) and via one or more appropriate interfaces (e.g., an API). The performance of certain of the operations may be distributed among the processors 704, not only residing within a single machine 700, but deployed across a number of machines 700. In some embodiments, the processors 704 or processor-implemented components may be located in a single geographic location (e.g., within a home environment, an office environment, or a server farm). In other embodiments, the processors 704 or processor-implemented components may be distributed across a number of geographic locations.

“CLIENT DEVICE” in this context refers to any machine that interfaces to a communications network to obtain resources from one or more server systems or other client devices. A client device may be, but is not limited to, a mobile phone, desktop computer, laptop, PDA, smart phone, tablet, ultrabook, netbook, laptop, multi-processor system, microprocessor-based or programmable consumer electronics system, game console, set-top box, or any other communication device that a user may use to access a network.

“COMMUNICATIONS NETWORK” in this context refers to one or more portions of a network that may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long range protocols, or other data transfer technology.

“MACHINE STORAGE MEDIUM” in this context refers to a component, a device, or other tangible media able to store instructions and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EPROM)), and/or any suitable combination thereof. The term “machine storage medium” should be taken to include a single medium or multiple media (e.g., a centralized or distributed database, or associated caches and servers) able to store instructions. The term “machine storage medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine storage medium” refers to a single storage apparatus or device, as well as “cloud-based” storage systems or storage networks that include multiple storage apparatus or devices. The machine storage medium is non-transitory and, as such, excludes signals per se. A computer storage medium is an example of a machine storage medium. The term “communications medium” in this context includes modulated data signals and other carrier/communication experience elements. The term “machine-readable medium” in this context includes both a machine storage medium (e.g., a computer storage medium) and a communications medium.

“PROCESSOR” in this context refers to any circuit (e.g., hardware processor) or virtual circuit (e.g., a physical circuit emulated by logic executing on an actual processor) that manipulates data values according to control signals (e.g., “commands,” “op codes,” “machine code,” etc.) and which produces corresponding output signals that are applied to operate a machine. A processor may, for example, be a central processing unit (CPU), a Reduced Instruction Set Computing (RISC) processor, a Complex Instruction Set Computing (CISC) processor, a graphics processing unit (GPU), a digital signal processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A method comprising:
accessing, by one or more hardware processors, input data comprising a set of hyperparameter values associated with one or more hyperparameters;
generating, by the one or more hardware processors, a validation decision tree ensemble based at least in part on training data and the input data, wherein the generating comprises the creation of a validation decision tree by storing prediction metadata in a non-leaf node of the validation decision tree in response to the non-leaf node satisfying a set of prediction data storage criteria based at least in part on the input data; and
from the input data corresponding to the one or more hyperparameters:
processing, by the one or more hardware processors, validation data using the validation decision tree ensemble based on the set of hyperparameter values;
collecting, by the one or more hardware processors, diagnostic data relating to the processing the validation data;
generating, by the one or more hardware processors, tuning data describing performance of the validation decision tree ensemble in response to the diagnostic data; and
storing, by the one or more hardware processors, the tuning data to at least one table in a database.

2. The method of claim 1, wherein the one or more hyperparameters includes at least one parameter relating to a number of edges between a root node and a leaf node, a parameter relating to size of a non-leaf node, a parameter relating to a number of validation decision trees in the validation decision tree ensemble, or a parameter relating to whether a node histogram is used for a prediction by the validation decision tree ensemble.

3. The method of claim 1, wherein the method is performed on a plurality of sets of hyperparameters.

4. The method of claim 3, wherein the at least one set of hyperparameters from the plurality of sets of hyper parameters comprises one or more collapsible parameters.

5. The method of claim 1, wherein the set of prediction data storage criteria includes a criterion that a depth of the non-leaf node within the validation decision tree that is specified by the set of hyperparameter values.

6. The method of claim 1, wherein the set of prediction data storage criteria includes a criterion that a size of the non-leaf node specified by the set of hyperparameter values.

7. The method of claim 1, wherein the storing the prediction metadata in the non-leaf node of the validation decision tree comprises:
determining a value, from the set of hyperparameter values, relating to whether a node histogram is used for a prediction by the validation decision tree ensemble; and
storing, if the value satisfies a first criteria, an empirical class distribution associated with the prediction data in the non-leaf node; and
storing, if the value satisfies a second criteria, raw prediction metadata in the non-leaf node.

8. The method of claim 1, wherein the diagnostic data comprises information relating to, with respect to the validation tree ensemble, at least one of an accuracy, a statistical diagnosis, a memory usage, or a performance.

9. The method of claim 1, wherein the storing the tuning data further comprises updating a tuning data table to include a row that comprises information derived from the set of hyperparameter values and the diagnostic data.

10. The method of claim 1, wherein storing the tuning data comprises storing the tuning data in a tuning data table and generating, by the one or more hardware processors, a decision tree ensemble based on second training data and based on one or more values from the set of hyperparameter values, wherein the values are obtained from the tuning data table.

11. A non-transitory computer-readable medium comprising instructions that, when executed by one or more hardware processors of a machine, cause the machine to perform operations comprising:
accessing input data comprising a set of hyperparameter values associated with one or more hyperparameters;
generating a validation decision tree ensemble based at least in part on training data and the input data, wherein the generating comprises the creation of a validation decision tree by storing prediction metadata in a non-leaf node of the validation decision tree in response to the non-leaf node satisfying a set of prediction data storage criteria based at least in part on the input data; and
from the input data corresponding to the one or more hyperparameters:
processing, by the one or more hardware processors, validation data using the validation decision tree ensemble based on the set of hyperparameter values;
collecting diagnostic data relating to the processing the validation data;
generating, by the one or more hardware processors, tuning data describing performance of the validation decision tree ensemble in response to the diagnostic data; and
storing the tuning data to at least one table in a database.

12. The non-transitory computer-readable medium of claim 11, wherein the one or more hyperparameters includes at least one parameter relating to a number of edges between a root node and a leaf node, a parameter relating to size of a non-leaf node, a parameter relating to a number of validation decision trees in the validation decision tree ensemble, or a parameter relating to whether a node histogram is used for a prediction by the validation decision tree ensemble.

13. The non-transitory computer-readable medium of claim 11, wherein the operations are performed on a plurality of sets of hyperparameters.

14. The non-transitory computer-readable medium of claim 13, wherein the at least one set of hyperparameters from the plurality of sets of hyper parameters comprises one or more collapsible parameters.

15. The non-transitory computer-readable medium of claim 11, wherein the set of prediction data storage criteria includes a criterion that a depth of the non-leaf node within the validation decision tree that is specified by the set of hyperparameter values.

16. The non-transitory computer-readable medium of claim 11, wherein the set of prediction data storage criteria includes a criterion that a size of the non-leaf node specified by the set of hyperparameter values.

17. The non-transitory computer-readable medium of claim 11, wherein the storing the prediction metadata in the non-leaf node of the validation decision tree comprises:
determining a value, from the set of hyperparameter values, relating to whether a node histogram is used for a prediction by the validation decision tree ensemble; and
storing, if the value satisfies a first criteria, an empirical class distribution associated with the prediction data in the non-leaf node; and
storing, if the value satisfies a second criteria, raw prediction metadata in the non-leaf node.

18. The non-transitory computer-readable medium of claim 11, wherein the diagnostic data comprises information relating to, with respect to the validation tree ensemble, at least one of an accuracy, a statistical diagnosis, a memory usage, or a performance.

19. The non-transitory computer-readable medium of claim 11, wherein the storing the tuning data further comprises updating a tuning data table to include a row that comprises information derived from the set of hyperparameter values and the diagnostic data.

20. A system comprising:
one or more hardware processors; and
a memory storing instructions configured to instruct the one or more hardware processors to perform operations of:
accessing first input data comprising a set of hyperparameter values associated with one or more hyperparameters;
generating a validation decision tree ensemble based at least in part on training data and the first input data, wherein the generating comprises the creation of a validation decision tree by storing prediction metadata in a non-leaf node of the validation decision tree in response to the non-leaf node satisfying a set of prediction data storage criteria based at least in part on the first input data; and
from the first input data corresponding to the one or more hyperparameters:
processing, by the one or more hardware processors, validation data using the validation decision tree ensemble based on the set of hyperparameter values;
collecting diagnostic data relating to the processing the validation data;
generating, by the one or more hardware processors, tuning data describing performance of the validation decision tree ensemble in response to the diagnostic data; and
storing the tuning data to at least one table in a database, and
generating a decision tree ensemble based at least in part on second training data and based at least in part on a one or more particular hyperparameter values corresponding to the one or more hyperparameters, the one or more particular hyperparameter values being obtained from a row of the at least one table; and
generating prediction data by processing second input data using the decision tree ensemble, the second input data being based at least in part on device data received from an Industrial Internet-of-Things (IIoT) device, and the second input data comprising a set of feature values.
